(19) United States
(12) Patent Application Publication
(10) Pub. No.: US 2023/0188770 A1
(43) Pub. Date: Jun. 15, 2023

(54) INTERACTIVE BROADCASTING METHOD AND SYSTEM

(71) Applicant: Noriyasu IKEDA, Kawasaki-shi (JP)

(72) Inventor: Noriyasu IKEDA, Kawasaki-shi (JP)

(21) Appl. No.: 17/925,212

(22) PCT Filed: Mar. 9, 2021
(86) PCT No.: PCT/JP2021/009282

§ 371 Date: Nov. 14, 2022

(30) Foreign Application Priority Data
May 19, 2020 (JP) 2020-087522

(51) Int. Cl. H04N 21/239; H04N 21/2187; H04N 21/466; H04N 21/235

(52) U.S. Cl. CPC H04N 21/239; H04N 21/2187; H04N 21/4667; H04N 21/235

(57) ABSTRACT

Current bidirectional broadcasting systems do not consider the reduced level of performance by performers when distributing a no-audience live performance. Provided is a bidirectional broadcasting method enabling an audience to enjoy a live performance distributed through a monitor, and characterized by comprising collecting reaction sound in real time from each audience member in response to a live distribution, outputting the real-time reaction sound from each audience member in response to the live distribution as an analog acoustic signal to speakers installed in a live event venue from which the live event is being distributed over a communication channel, and communicating, to a live performer in real time, the reactions of the audience members to the live distribution.

### TECHNICAL FIELD

The present invention relates to a live distribution method and a live distribution system and, more particularly, to an interactive broadcasting system that performs live distribution via a communication line.

### BACKGROUND TECHNIQUE

People are being required to stay home to reduce the impact of the novel coronavirus (COVID-19) infection. For this reason, live performances of entertainments, such as sports, music, and performing arts, have been canceled or postponed across the board. Therefore, companies, organizations, and individuals involved in these entertainments, as well as players, athletes, and entertainers (hereafter referred to as performers, etc.) who are performers at those events, are driven to dire financial straits.

On the other hand, the spread of COVID-19 is still unstoppable, and it is completely unknown when it will end.

Particularly during the period when people are required to refrain from going out, it is necessary to find comfort and enjoyment through entertainments. For now, however, it is at best possible to watch personal play of a performer via Internet or the like. In reality, it is not possible to enjoy music and sports at large, medium and small live venues such as theaters and ballparks.

Live distribution using the Internet is actually performed by performers and the like. In the live distribution, video and audio of the performers can be viewed via a computer, a smartphone, etc. In this case, there is also a mechanism in which viewers can write their impressions, etc., and the written impressions, etc. are displayed on a live screen of the computer or the smartphone in real time (Non-Patent Literature 1).

However, the performers playing at the live venue cannot know reactions of the viewers in real time at the live venue. For this reason, the performers can only know the reactions of the viewers recorded after the live performance, and cannot know in real time what the reactions of the viewers are. As a result, those events with no audience might often result in poor performance of the performers.

On the other hand, Patent Literature 1 discloses a system for providing communication services using multimedia communication for transmitting information using a plurality of information media. Patent Literature 1 also discloses a multi-client interactive conference service that enables video and audio information conferences between a plurality of client terminals. Further, Patent Literature 1 also discloses providing a live broadcasting PC for executing live broadcasting.

However, Patent Document 1 does not consider no-audience live distribution at all.

### PRIOR ART LITERATURE(S)

### Patent Literature(s)

Patent Literature 1: JP 2002-359831A

### Non-Patent Literature(s)

Non-Patent Literature 1: Niconico Live Broadcasting (registered trademark) TOP page (URL: https://live.nicovideo.jp/)

### SUMMARY OF THE INVENTION

### Problem to be Solved by the Invention

The problem to be solved is that, in no-audience live broadcasting, the reactions of the viewers cannot be notified to the performers in real time, so the performers cannot necessarily concentrate on the play, the game, and the like.

Furthermore, no-audience live performance through the Internet is not economically advantageous for event operators and players because the costs for the no-audience live performances are uncertain.

### Means to Solve the Problem

According to a first aspect of the present invention, there is obtained a no-audience live broadcasting method in which live distribution can be viewed through a monitor, the method comprising outputting as an analog sound signal a viewer's reaction voice to the live distribution to a loudspeaker installed in a live venue where the live distribution is performed, and notifying a live performer of a viewer's reaction to the live distribution in real time.

According to a second aspect of the present invention, there is obtained an interactive broadcasting system which comprises a user terminal including a monitor for receiving video and audio of a live venue and a user microphone for transmitting user's voice, and a live-venue-side device which outputs the user's voice to a loudspeaker installed in the live venue, the user's voice being adjusted in timing with respect to the video and the audio of the live venue.

According to a third aspect of the present invention, there is obtained the interactive broadcasting system described in the second aspect, wherein the video and the audio of the live venue are no-audience live video and audio produced in a no-audience state.

According to a fourth aspect of the present invention, there is obtained the interactive broadcasting system described in the second or the third aspect, wherein the user terminal and the live-venue-side device are connected via the Internet.

According to the fifth aspect of the present invention, there is obtained the interactive broadcasting system described in the fourth aspect, further comprising a center server connected to the Internet, wherein the user terminal and the live-venue-side device are connected via the center server and the Internet, and the user's voice and the no-audience live video and audio are transmitted and received via the center server.

### Effect of the Invention

According to the present invention, the performers and the like can obtain the same sense of realism as in the case where a large number of audiences are present at the live venue, despite no audience. Furthermore, even when watching a no-audience live performance, the viewers can inform the performers, etc., of their impressions to performances by the performers. By recording, selling, and billing for the video, audio, and user's voice of the no-audience live performance, users can be notified of the excitement of the live performance or the like. In addition, by restricting the number of viewers, it is possible to stabilize the income of players, planning companies, etc. by selling tickets and the like associated with the no-audience live performances in advance via the Internet.

### DETAILED DESCRIPTION OF THE INVENTION

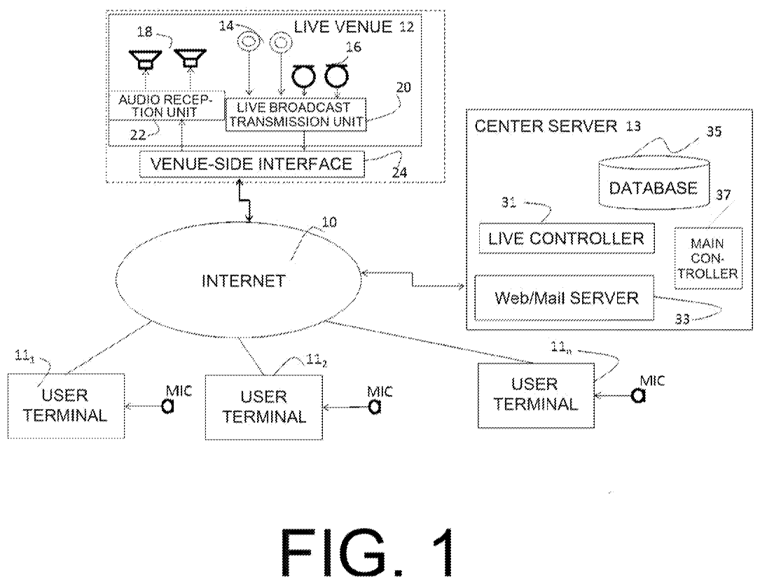

FIG. 1 is a block diagram showing an example of an interactive broadcasting system according to an embodiment of the present invention;

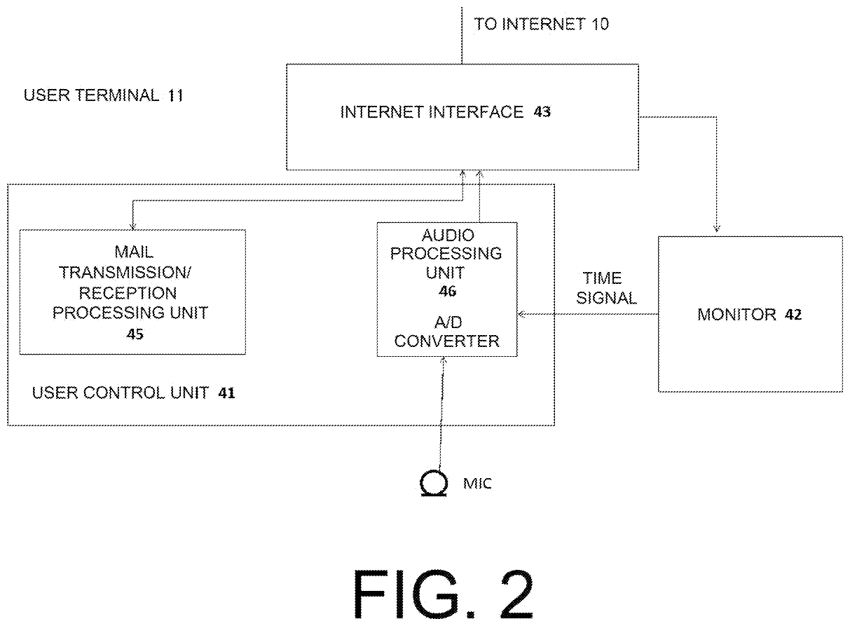

FIG. 2 is a block diagram showing a schematic configuration of a user terminal shown in FIG. 1; and

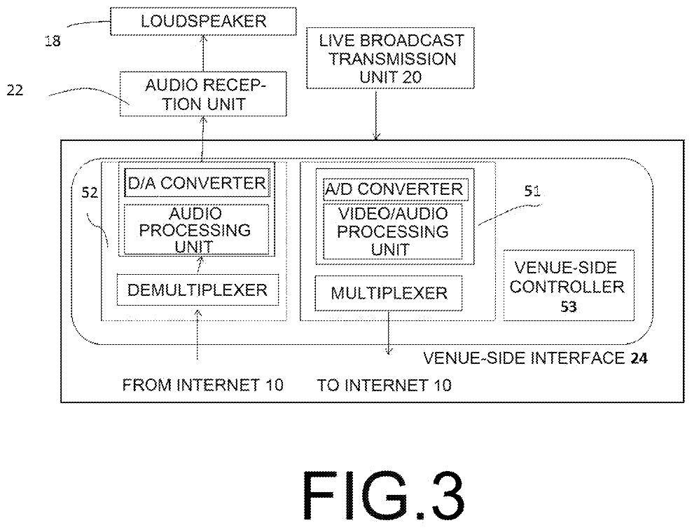

FIG. 3 is a block diagram illustrating a venue side interface shown in FIG. 1.

### MODE FOR EMBODYING THE INVENTION

FIG. 1 shows an interactive broadcasting system according to one embodiment of the present invention. The interactive broadcasting system shown in FIG. 1 is an interactive broadcasting system using the Internet 10. Incidentally, a communication line or channel may include a mobile communication network and a cable television network. The illustrated interactive broadcasting system includes a large number of user terminals 11₁-11ₙ connected to the Internet 10, a live venue 12, and a center server 13. Each of the user terminals 11₁ to 11ₙ has a monitor (not shown) that reproduces live video and audio from the live venue 12, along with a microphone MIC that picks up and transmits user's own voice. Incidentally, the illustrated microphone MIC may be a microphone built in the monitor. The monitor is a monitor of a PC or the like, or a monitor of a portable terminal, but may be a monitor of a television if it can perform interactive communication.

The live venue 12 shown in FIG. 1 is equipped with a plurality of television cameras 14, a plurality of microphones 16, and loudspeakers 18 as venue-side devices. The television cameras 14 and the microphones 16 illustrated in the figure are connected to a live broadcast transmission unit 20, while the loudspeakers 18 are connected to an audio reception unit 22.

The live broadcast transmission unit 20 and the audio reception unit 22 are connected to the Internet 10 via a venue side interface 24. The live broadcast transmission unit 20 digitizes the live video and audio from each of the television cameras 14 and the microphones 16, combines and mixes them using a normal distribution method, and outputs them to the venue side interface 24.

Here, the venue side interface 24 has a function of transmitting digitized video and audio signals to the Internet 10 in a format compatible therewith. Furthermore, the venue side interface 24 includes a D/A conversion unit that multiplexes the digital audio signals from the user terminals 11₁ to 11ₙ and converts the multiplexed digital audio signals into analog audio signals. In this case, the digital audio signals from the plurality of user terminals 11₁ to 11ₙ are synthesized and sent to the audio reception unit 22. As a result, the audio reception unit 22 synthesizes the plurality of analog audio signals from the venue side interface 24 and drives the loudspeakers 18. Thus, analog sound signals, such as cheering, scream of delight, and applause from many users are output in the venue. In this case, analog audio signals reproduced in the venue may be picked up by the microphones 16, converted into digital audio signals by the live broadcast transmission unit 20, and sent to the venue side interface 24.

The live video and audio of the live venue 12 are digitized by the live broadcast transmission unit 20, combined by the venue side interface 24, and transmitted to the Internet 10. The live broadcast transmission unit 20, the audio reception unit 22, and the venue side interface 24 described above may be realized by hardware or by software.

The digital video signals and the digital audio signals from the venue side interface 24 including live video and audio are transmitted to the center server 13 via the Internet 10. The center server 13 includes a live controller 31, a Web/Mail server 33, and a database 35. Also, in the illustrated example, a main controller 37 for controlling them is provided.

Under the control of the main controller 37, the live controller 31 identifies each user terminal 11 to which the digital video and audio signals sent via the Internet 10 are distributed, and transmits the digital video and audio signals via the Internet 10 to each identified user terminal 11 to perform live distribution. Also, the received digital video and audio are stored in the database 35 under the control of the main controller 37 so that, even after the end of the live performance, the live video and audio can be viewed afterward according to a user's request.

The live controller 31 has a function of carrying out control of live video and audio, time control, user management, and management of schedules related to the live performances and so on.

On the other hand, the Web/Mail server 33 identifies an account of each user terminal 11 sent via the Internet 10, receives e-mails, messages, etc. from the identified user terminal 11, and sends them via the Internet 10 to the live venue 12. The Web/Mail server 33 identifies whether or not a user is permitted to view the live performance from the account of the user terminal 11 or the like, and permits the identified user terminal 11 to view the live performance. The user who is permitted to view can send his/her impression or the like by an e-mail or a message, and the content of the sent e-mail or the like is reflected in the live video from the live venue 12.

In the interactive broadcasting system described above, many users who are permitted to view can output their impressions and excitement for the live performance etc. to the live venue 12 as voice in the form of sound signals. Therefore, despite the no-audience live performance, it is possible to convey, to the performers, the excitement as if the audiences were seated at the live venue 12.

FIG. 2 is a block diagram showing an example of the user terminal 11 shown in FIG. 1. The user terminal 11 has a user control unit 41, a monitor 42, and an Internet interface 43. The illustrated user control unit 41 includes an e-mail transmission/reception processing unit 45 and an audio processing unit 46. It is assumed that the e-mail transmission/reception processing unit 45 is connected to an input/output device (not shown), such as a keyboard. The input/output device may be a voice input type. The e-mail transmission/reception processing unit 45 outputs the e-mail input by the user to the Internet interface 43.

The audio processing unit 46 is connected to the microphone MIC and the monitor 42. The audio processing unit 46 includes an A/D converter that receives an analog audio signal indicating user's impression from the microphone MIC and converts the analog audio signal into a user digital audio signal. Further, the audio processing unit 46 receives a time signal from the monitor 42, adjusts the timing of the user digital audio signal and the live video and audio received by the monitor 42, and outputs the time-adjusted digital audio signal to the Internet interface 43. The Internet interface 43 combines the digital audio signal and an identification signal of the user, converts them into a packet signal or the like, and outputs the packet signal to the Internet 10.

The e-mail from the mail transmission/reception processing unit 45 may be output independently of the digital audio signal or the like from the audio processing unit 46, or may be mixed to be output.

The packet signal containing the voice of each user is transmitted from the Internet 10 to the center server 13, and the center server 13 transmits the timing-adjusted user digital audio signal to the audio reception unit 22 of the live venue 12 via the Internet 10. It is assumed that the center server 13 has adjusted the schedule with the live performance in advance.

As a result, at the live venue 12, users' voices expressing impressions and excitement with respect to the live video and audio are almost simultaneously notified to the performers and the like.

FIG. 3 is a block diagram showing the venue side interface 24 shown in FIG. 1. The illustrated venue-side interface 24 has a live signal processing unit 51 that processes video and audio from the live broadcast transmission unit 20, and a user-side audio processing unit 52 that processes user-side audio signals. The live signal processing unit 51 and the user-side audio processing unit 52 are controlled by a venue side controller 53.

The live signal processing unit 51 includes an A/D converter that receives a video signal and an audio signal from the live broadcast transmission unit 20 and performs A/D conversion, a video/audio processing unit that converts the A/D converted signals into a signal format suitable for the Internet 10, a multiplexer, and the like.

On the other hand, the user-side audio processing unit 52 has a demultiplexer for separating the digital audio signal from the user, and an audio processing unit including a D/A converter for D/A converting the separated digital audio signal. The D/A converted analog audio signal is sent to the audio reception unit 22 and converted into a signal for driving the loudspeaker 18.

If viewers' accounts, etc. are identified by the center server and viewers' information is registered before start of the no-audience live distribution, the number of viewers, etc. can be specified before the live distribution. Then, fees can be collected in advance from the viewers for the no-audience live distribution to remove financial concerns for the performers. In this case, if a position in the live venue corresponding to a seat is determined for each viewer based on the viewer's account and the viewer information, the live distribution can be enjoyed with more realistic feeling. Furthermore, broadcasted contents of the live distribution may be stored in the database and, after the live distribution, the video and audio accompanying the live performance can be distributed at a later date upon a viewer's request, or can be stored in a separate storage medium to be sold. The present invention is not necessarily limited to no-audience live distribution, but may also be applied to small-audience live distribution.

### Industrial Applicability

According to the present invention, it is possible to give performers and the like performing, in interactive Internet broadcasting, live distribution for live performances requested to be held in a no-audience state, the equivalent impression and deep emotion to those at a live venue. The present invention is not limited to wired networks, but may also be applied to 4G or 5G wireless networks.

### DESCRIPTION OF REFERENCE NUMERALS

10 Internet;
11₁ to 11ₙ User terminal;
12 Live venue;
13 Center server
14 Television camera;
16 Microphone;
18 Loudspeaker
20 Live broadcast transmission unit;
22 Audio reception unit
24 Venue side interface
31 Live controller
33 Web/Mail server
35 Database
37 Main controller
41 User control unit
42 Monitor
43 Internet interface
45 Mail transmission/reception processing unit
46 Audio processing unit
51 Live signal processing unit
52 User side audio processing unit
53 Venue side controller

1.-5. (canceled)

6. An interactive broadcasting method in which live distribution is enjoyed through a monitor, the method comprising:
registering, as each viewer information, information related to each seat position in a live venue together with each viewer's account;
collecting each viewer's reaction voice to the live distribution in real time;
outputting, through each loudspeaker installed at the live venue where the live distribution is performed, each viewer's reaction voice to the live distribution in the form of an analog acoustic signal in real time;
informing a live performer of each viewer's reaction in real time; and
determining each seat in the live venue for each viewer based on the viewer information related to each seat position in the live venue, together with the viewer's account.

7. An interactive broadcasting system comprising:
a live-venue-side device for live distributing live video and live audio at a live venue equipped with a plurality of television cameras, a plurality of microphones, a plurality of seats, and a plurality of loudspeakers;
a center server that registers a viewer' s account and viewer information including seat information of each seat in the live venue and that virtually determines a seat position of each viewer in the live venue based on the seat information together with the viewers' account; and
a user terminal equipped with a monitor to receive the live video and the live audio and a microphone to transmit each viewer's voice;
wherein each viewer's voice is output to the loudspeakers at the live venue, and each viewer enjoys the live video and the live audio in the live distribution in dependency upon each viewer's seat position.

8. The interactive broadcasting system according to claim 7, wherein the live video and the live audio are produced at the live venue in a non-audience state.
